(19) United States
(12) Patent Application Publication
(10) Pub. No.: US 2003/0065967 A1
(43) Pub. Date: Apr. 3, 2003

(54) Troubleshooting engine and method for using same

(76) Inventors: Joel Garcia, San Diego, CA (US); Craig Arnush, San Diego, CA (US); Balan Tholandi, San Diego, CA (US); Jeff Mazon, San Diego, CA (US); Luc Tran, San Diego, CA (US); J. Dilan Celi, San Diego, CA (US)

Correspondence Address: NOVAKOV DAVIS & MUNCK, A PROFESSIONAL CORPORATION, Docket Clerk, P.O. Box 802432, DALLAS, TX, 75380, US

(21) Appl. No.: 09/967,874

(22) Filed: Sep. 29, 2001

(51) Int. Cl. H02H 3/05

(52) U.S. Cl. 714/1

(57) ABSTRACT

A system for using a troubleshooting engine to assemble an interactive multimedia repair guide for assisting a service technician in the repair of a defective product, and a mehof of using the same. The system includes a dynamic knowledge database for storing product history records relating to defects reported concerning the product. The database also contains design information related to the product for correlation with the defect reports and use in analyzing future reported defects. The integrated quality management system also includes a product performance counter (PPC) analysis module that receives PPC data from an individual product, generates a PPC profile based on the received data, and compares the profile to stored design and historical PPC profiles to produce a weighted prediction report of likely defects. This report is transmitted to the troubleshooting engine, which directs a multimedia application to transmit diagnosis and repair instructions to a service center technician.

This invention relates generally to the service and repair of defective products, and more specifically to a system and method for the providing a network-based interactive multimedia repair guide for use in addressing reported product defects at remote service facilities.

### BACKGROUND OF THE INVENTION

For many mass-market, that is, very widely-distributed consumer products, the chain of product development, design, production, and distribution follows a familiar pattern. The pattern is followed because sales of hundreds, even thousands of the same or very similar products are expected to be sold through a great many retail stores. Products are designed by one group of people, manufactured by others—perhaps even a different company entirely—and then shipped for distribution and sale. Distribution is usually through regional, then local distribution centers, and finally to the retail outlets where they will be sold. In this type of market, the people at one end of the chain often have very little direct contact with those at the other. In any such scheme, a certain number of product defects of uncertain origin are likely to go undiscovered until they appear at the retail level, either before or after the product is sold to a consumer. A customer who discovers a product defect cannot possible know where in the chain the defect originated, so problems perceived at this level are generally first dealt with the retail outlet where the item was purchased or a local service center. Unfortunately, these members of the chain are the ones most distant from the design and manufacturing groups where the defects were very likely introduced.

Moreover, mass-market products are ubiquitous in the modern world. Where once a single electrical device such as a radio, television, or telephone might be among a family's most prized possessions, many homes are now filled with literally dozens of such devices. Correspondingly, the number of retail outlets at which electrical devices such as mobile phones, personal digital assistants (PDAs), calculators, computers, DVD players, and the like, are sold has also increased dramatically. Such retail outlets may no longer specialize in a particular line of electrical devices, but may sell them as part of a wide selection of household goods.

A typical feature of modern retailing, however, is the consumer's ability to bring a previously-purchased product back to the retailer and obtain a refund of the purchase price or some other consideration. This works to the consumer's advantage especially when a defective product has been purchased. It may also work to the advantage of the manufacturer when, instead of employing extensive (and expensive) measures to ensure every device is in perfect working order, an easy return or exchange process means that a higher number of defective products may be acceptable to the public at large. Returned products are not simply scrapped, however. Some can be repaired and resold, presumably having been restored to the originally-intended level of quality. And some “returns” are not defective at all, but simply returned because they did not meet the customers' needs for other reasons.

Returns are not without cost, however, when a customer brings back a product and claims it is defective. An attempt may first be made at a quick repair. To do this, an accurate description of the defect must be given, and an appropriate fix performed. Note, however, that in most, if not all, cases, the consumer will report only symptoms of a defect—the unacceptable performance they encountered. They have little or no way of actually determining the root cause of this unacceptability, that is, the actual defect. Not being experts, consumers may be susceptible to misreporting symptoms of the defect, making diagnosis all that more difficult. Moreover, customers who wish to return products may intentionally misreport problems out of a fear that their return for other reasons will not otherwise be accepted. And of course, with most defects in electronics devices, the presence or absence of a defect is not normally easy to identify by simple visual inspection.

Ultimately, this means that dozens, even hundreds of technicians are forced to address problems and cure defects occurring in products that that they had no part in creating and that many times they may be only generally familiar with. Moreover, because thousands of units of a product may be manufactured and shipped in a short period of time, there is a high probability that many of these technicians are independently addressing the same defects as other, distant technicians, and independently having to discover the same or similar solutions.

Reported defects may be real, or result from the consumer's unrealistic expectations or inability to properly operate the product. Real defects include both those endemic to the entire line of products—perhaps due to a design or manufacturing flaw—and those related only to certain individual products, or a relatively small set of the total number manufactured. Whatever the type or origin of the defect (this term herein meant to include both real and imagined defects unless otherwise specified or apparent from the context), the myriad and scattered service technicians will have to address it with little outside guidance, at least initially. Although these technicians are free to call others, or to contact the engineers or factory representatives, they cannot efficiently engage in extensive research and study to determine the cause each and every reported problem and work out optimum solutions. As a result, there exists little or no easy way to efficiently benefit from the experiences of others.

One way in which this issue has been addressed is through what may be referred to as a “reporting and bulletin” system. Over the life of a commercial product, any problems commonly encountered are usually reported to a central service site. The problem report may include not only a description of the problem, but a proposed solution or suggestion as well. Or the central service facility may analyze common defects in an effort to come up with an appropriate way to address them. When sufficient data has accumulated, a service bulletin can be issued to all of the service technicians to provide them with guidance on how to deal with the particular problem covered in the bulletin.

Unfortunately, this method, however reliable, is often too slow to react to problems encountered with newly-released products, especially in industries where new releases are frequent. Only after sufficient time has elapsed will enough service bulletins have been issued to cover the vast majority of problems that are likely to be encountered. When a product (and the defects endemic to it) is very new, there is still very little to report in a service bulletin, and the collection and dissemination process does take a certain amount of time. As a result, situations arise frequently where an unknown defect is reported at a service center, and has to be handled without benefit of the collective experience that the service bulletins represent. This will remain the case until a quantity of experience has been amassed, reported, and incorporated into a service bulletin. This time delay, however, is unacceptable in industries such as the present wireless telephone industry, where new product releases occur very frequently. In such industries, the state of the underlying technology often advances so fast that even products released in the past one or two years are nearing obsolescence. By the time that recurring problems have been sufficiently documented and solutions proven, it is very nearly time for release of the next generation of products.

Needed, then, is an inexpensive and efficient method of rapidly developing a centralized database, along with an intelligent problem-solving routine to enable widely distributed service centers to more quickly and efficiently be able to handle problem reports, especially those associated with a new product release.

### SUMMARY OF THE INVENTION

It is an object of the present invention to provide an efficient problem-resolution system and methodology usable by service technicians for assistance in the repair of defective products.

In one aspect, the present invention is a troubleshooting engine including a multimedia session assembly module for assembling an interactive multimedia repair guide. The troubleshooting engine further includes a communication module for communicating with the service technician to receive information related to the defective product, a memory device for storing at least some of the received information so that it can be referred to when assembling the repair guide, and a multimedia library from which to draw prepared multimedia materials that may be used in multimedia repair guide assembly.

In another aspect, the present invention is a distributed service system having a troubleshooting engine in communication with a database for storing historical repair and product design information that the troubleshooting engine may refer to in preparing a repair guide for use by a service technician attempting to perform repairs on a defective product. The repair guide is preferably an interactive multimedia repair guide, and information gathered during the interactive repair session is used to supplement the historical repair information in the database. In a particularly preferred embodiment, the system also includes a PPC analysis module for analyzing any PPC counts provided by the defective product and fed to the PPC analysis module.

In yet another aspect, the present invention is a method of assisting a service technician attempting to repair a defective product that includes the steps of providing a troubleshooting engine, collecting information related to the product defect, transmitting the information to the troubleshooting engine, and using the information to assemble an interactive multimedia repair guide for transmission to the service technician. The method may further include providing an historical knowledge database in communication with the troubleshooting engine for storing historical repair data that also may be used by the troubleshooting engine in assembling the repair guide. Information gathered during execution of the repair process is provided to the database so that the historical data may be supplemented.

### BRIEF DESCRIPTION OF THE DRAWINGS

FIG. 1 is a block diagram of an intelligent distributed service system incorporating the troubleshooting engine according to an embodiment of the present invention;

FIG. 2 is a flow chart illustrating an embodiment of a distributed service system repair process according to an embodiment of the present invention; and

FIG. 3 is a block diagram illustrating the major components of an exemplary troubleshooting engine configured in accordance with an embodiment of the present invention.

### DETAILED DESCRIPTION OF THE INVENTION

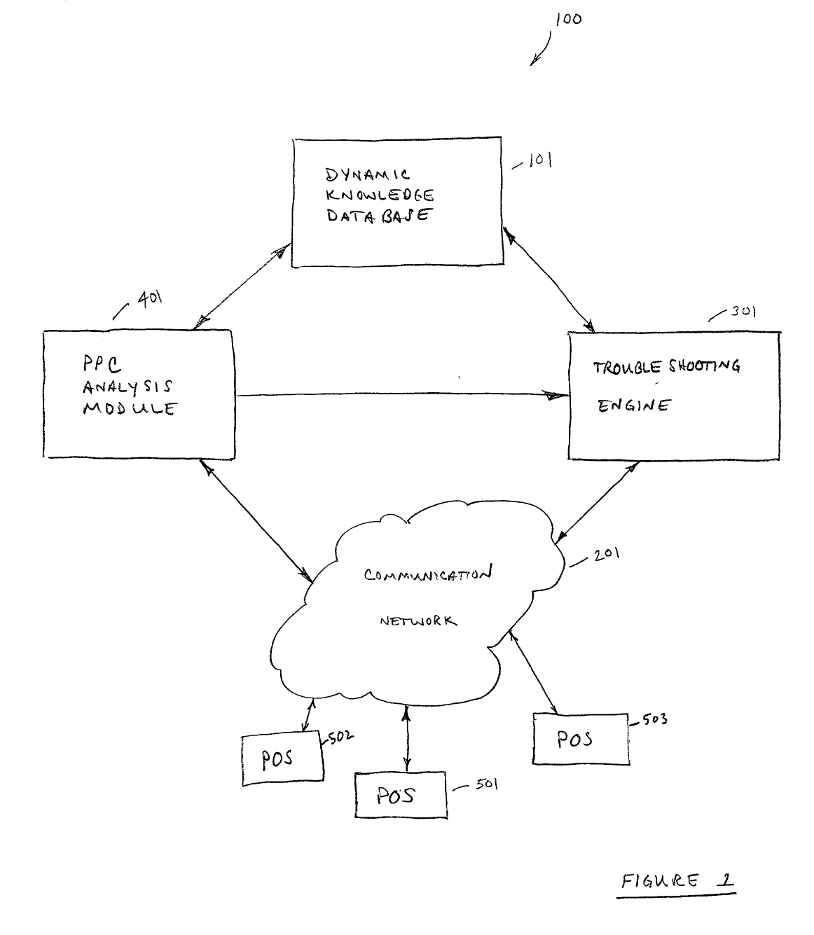

FIGS. 1 through 3, discussed below, and the various embodiments used to describe the principles of the present invention in this patent document are by way of illustration only and should not be construed in any way to limit the scope of the invention.

FIG. 1 is a block diagram of an intelligent distributed service system 100 incorporating a troubleshooting engine 301 according to an embodiment of the present invention. Note the present invention is directed both to a troubleshooting engine specifically, and as well to its application in a system such a distributed service system 100. Distributed service system 100 includes dynamic knowledge database 101, which is a constantly updated knowledgebase of information relating to previously encountered defects (again, real and imagined) along with both proposed, and proven solutions for addressing them. Knowledge database 101 is updated both automatically by system 100 and manually by engineers and service personal as new problems are encountered and their solutions developed. Dynamic knowledge database 101 is preferably an organized database of an organization's entire collective remedial-action experience. In part this experience is documented and collected as in the past, by service technicians generating defect reports that are submitted to a central department for analysis. In addition, however, certain information is collected automatically as the repair process is interactively guided by the by troubleshooting engine 310.

Complimenting dynamic knowledge database 101 is PPC analysis module 401. PPC analysis module 401 receives input obtained from the defective product itself, including (though not limited to) the contents of a product's product-performance counters (PPCs). Armed with this data, PPC analysis module 401 prepares a product profile based on the PPC contents, and any other inputs it receives, and compares this profile to others represented in the design and collective-experience data in dynamic knowledge database 101. Based on this comparison alone, it may be possible to determine precisely the cause of the reported problem, although more likely a number of possible causes will be identified, each consistent with the received PPC data. Each possible defect cause may be ranked, again with reference to the knowledge accumulated on dynamic knowledge database 101 to indicate if determinable which cause is most likely to be correct, then which is next most likely, and so forth. In a particularly preferred embodiment, this ranking includes a relative certainty value, indicating how much more likely the defect is a result of one cause as opposed to another. This ranking and, when present, an associated certainty value may be reported to the service technician to aid in their analysis. In this embodiment, when a certain cause is associated with a sufficiently high probability, any other alternatives may simply go unreported, or may be reported only on request. The service technician in this way can eliminate from view distracting and probably unnecessary information. In another embodiment, the ranking and certainty information is used only for the purpose of directing repairs through the interactive service guide.

Communication network 201 is a network connecting the PPC analysis module 401 and the various points of service (POSs) such as POS 501, POS 502, and POS 503. Communication network 201 is very likely to include the Internet (and any necessary access channels), but may also be, where useful, a local area network (LAN), a wide area network (WAN), a virtual private network (VPN), or some other public or private communication network. The greatest advantage obtains, however, when the communication network 201 selected is the most efficient and reliable way to connect the POSs and the other components of distributed service system 100. The Internet typically fulfills these criteria, but may not always be the optimum network. Of course, the network does not have to be either homogenous or static, and separate POSs may access the rest of the system by different and changing means.

Note that although three POSs are shown, there could be any number; very likely there are dozens, even hundreds. Some may be nearby, others distant. Some may be relatively permanent, while others are mobile, occasional, or purposefully in existence only for a short time. A POS may even effectively be in more than one location (not shown), such as where a product brought into one location is being remotely examined by a service technician in another. Naturally, the nature of the network connection to each POS through communication network 201 may vary according to the aforementioned factors. In some instances, some or all of the system 100 may be replicated for ease of access, or provided on a removable storage media (such as a CD) for use even if continuous communication is not possible or desirable. Note also that certain POSs may be provided with more or less service relative to others, or each permitted to have access to only a certain amount of information. This may be a useful limitation where a particular POS also services the products of competitors.

Troubleshooting engine 301 is at the heart of the distributed service system 100 because it takes the information stored and generated by the other system components and applies it to a process for assisting the service technician who is addressing the defective product. Specifically, troubleshooting engine 301 receives the report produced by PPC analysis module 401 and uses the defect-prediction information contained in it, along with the design and collective-experience information on database 101, to assemble an interactive multimedia guide for use by the service technician so that problems can be quickly diagnosed and, where possible, repaired.

Note that in a preferred embodiment, such as the one of FIG. 1, dynamic knowledge database 101, troubleshooting engine 301, and PPC analysis module 401 are preferable linked to one another and co-located. They may actually reside in the same physical device and share its resources. The various POSs, on the other hand, are often remotely located and connected to the remainder of system 100 by communication network 201. This configuration is not required, however, and in an alternate embodiment, a POS (not shown) may be nearby and directly connected (or even share the same physical unit). Likewise, dynamic knowledge database 101, troubleshooting engine 301, and PPC analysis module 401 may be remote located from one another and, if so, may rely on communication network 201 as well.

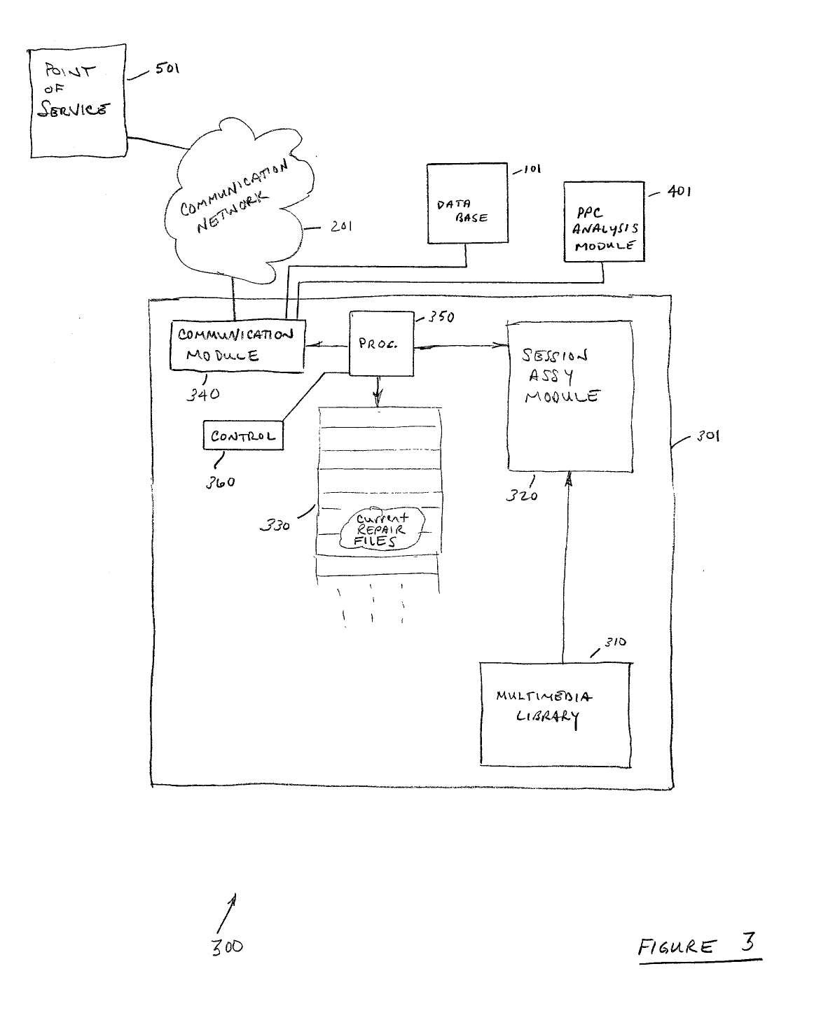

Turning to FIG. 3, there appears a block diagram illustrating the major components of an exemplary troubleshooting engine 301 configured in accordance with an embodiment of the present invention. Troubleshooting engine 301 includes a communication module 340 for sending and receiving communications through the communications network 201, through which it maintains contact with one or more POS (such as POS 501 shown here). Note again that communications network 201 may include segments of different communications networks, including the Internet, a VPN, satellite network, or the like, that is capable of handling multimedia communications between troubleshooting engine 301 and point of service 501. Generally, this communication channel will be the one through which the interactive multimedia repair guide session is conducted, although any other channel may be used as well, for example one established through PPC analysis module 401, as necessary or desirable under the circumstances. Preferably, communications module 340 is capable of transmitting and receiving through a variety of network configurations, and may in fact be capable of quickly switching from one to another if a certain channel is for some reason interrupted or unavailable.

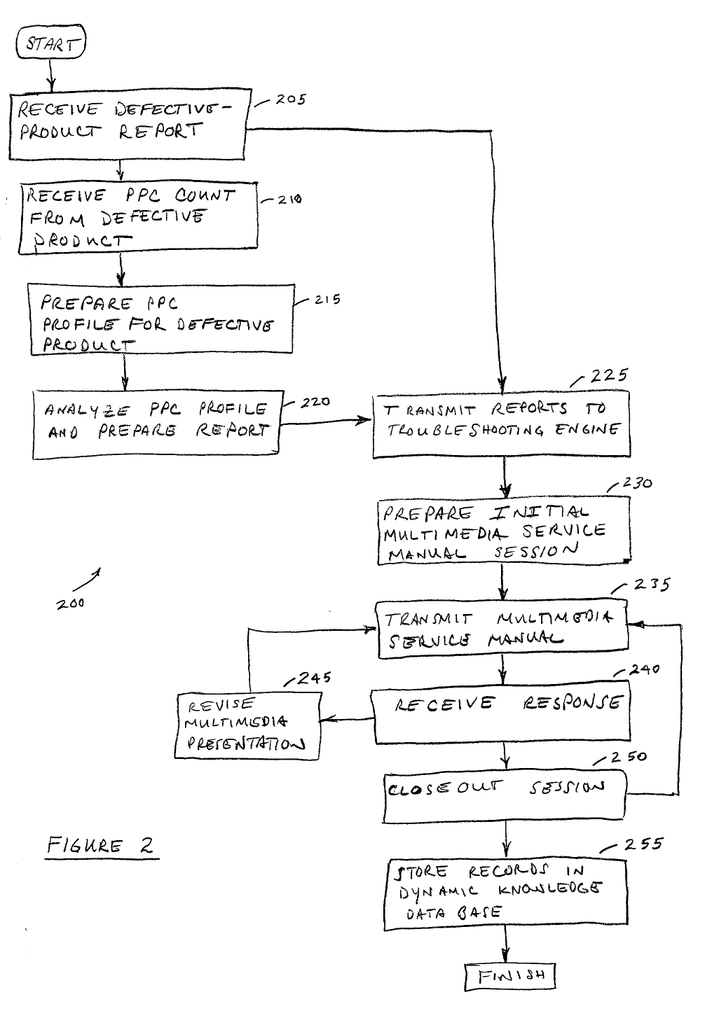

Troubleshooting engine 301 also includes a multimedia service manual assembly module 320, a multimedia library 310, and current-repair file 330. When a problem report is received and processed (see FIG. 2 and the discussion of it below), the results are sent to troubleshooting engine 301, either through a direct connection if the basic components of the distributed service system 100 (see FIG. 1) are physically co-located with troubleshooting engine 301, or through communications network 201. Any other relevant information may also be sent to troubleshooting engine 301 at this time if it has not already been transmitted. This information is stored in current repair files 330. There may, of course, be many repair sessions being conducted simultaneously, and current repair files 330 maintain data relating to each of them for use by any of the system 100 components as needed. Session assembly module 320, for example, uses this information to assemble an interactive multimedia service manual customized for the particular product being addressed, and for the defect symptoms encountered (as reported or as generated by the PPC analysis). Although current repair files 330 will ordinarily not themselves store all of the of the multimedia service manual used in a given session, the files will usually maintain a record of what content has been transmitted to point of service 501, and also the responses received in return. (Note again that although only one point of service is shown, there could be any number of them.) Processor 350 under the direction of control program 360 refers to current repair files 330 in order to properly direct the session assembly module 320 in assembling the multimedia repair session, for example by indicating which suggestion to make or what additional information to request. Finally, multimedia library 310 contains various pre-developed multimedia-presentation content for use by session assembly module 320 in preparing an ongoing multimedia session.

Turning now to FIG. 2, there appears a flow chart illustrating an embodiment of a distributed service system repair process 200 according to an embodiment of the present invention. Initially (START), it is presumed that products are provided with product performance counters (PPCs) either at manufacture or by retrofit. The “product” may be any type of product, but the process of the present invention is most advantageously employed in connection with mass-distribution consumer electronics products such as mobile phones, computers, personal digital assistants (PDAs), televisions, and similar products. (Large customized products, in contrast, are less likely to be serviced in a widely-distributed service system.) A PPC is an internal detector that can be used to detect the occurrence of a certain event in the product, especially one that can be associated with a given defect. The detector is associated with a counter in non-volatile memory, where the number of times a certain event occurs is tracked. A time and data stamp or clock time may be associated with the PPC so that when an event occurs can be tracked as well, or at least its frequency as related to device-operation time. A given device will normally have numerous PPCs, each tracking the occurrence of different events. For example, in the mobile phone environment, PPCs can be used to measure events such as dropped calls, access-attempt failure, software and hardware resets, and origination failures. Each of these events is a symptom, of course, and not an actual defect. In combination with statistics related to device operation, such as call and standby time, minutes being recharged, etc., however, PPCs can be used to construct a profile of the device's operational life.

As mentioned above, a PPC-based profile is used in the diagnostic portion of the quality control process by comparing it to an analogous profile for a device known to be defect-free, or to profiles of devices having a known defect. Based on this analysis alone, it may be possible to predict with a measurable amount of certainty the root cause of a problem. Again, PPCs cannot detect defects directly, but can be used to statistically predict what the defect will be, or at least provide a course of action most likely to find the defect and result in an effective repair.

Step 205, data accumulation, generally occurs in all PPC-equipped devices, both satisfactory and defective, while they are in the user's (or in some instances, the service technician's) possession. The PPC counts are stored in memory until it is full, then new count data is added to memory by discarding selected portions of the data already stored. Step 210 occurs when a product is returned for repair, or alternately when initiated by a customer. Note that products may be returned to the seller for a number of different reasons. One reason, of course, is a real defect that the user wishes to have remedied. At this point, it is usually unknown whether the product will be repaired or replaced, or how long any potential repairs will take. Even if a customer accurately and truthfully reports the problems with operating the product, the determination is not easily made. It is in the interest of both consumer and service center, however, that a course of action be promptly decided on and executed.

A returned product is first connected with a device that can read the PPC memory and report the various PPC counts stored there (step 215). This will frequently be a connection established by a service technician to an appropriate service-center terminal provided for the purpose. In an alternate embodiment applicable to mobile phones and other communicative products, the customer may be provided with a number or electronic address to contact in the event the product's performance appears to be below an acceptable standard. In this embodiment, the product must, of course, be working well enough to establish such contact. When contact is made, the PPC count may be downloaded through whatever communication channel is being used (preferably after the customer somehow indicates their permission to do so). In yet another embodiment, the device can be connected to a properly configured personal computer and the PPC counts automatically transmitted over an Internet connection.

At step 220, a PPC algorithm, formulated for use in analyzing the PPC counts when they are received, is applied to the collected product counts and a result obtained. The PPC algorithm may originally have been written using design specific action and predictive error analysis, but is preferably updated on a regular basis to adjust for experience. In a preferred embodiment, the system 100 is capable of updating the algorithm automatically based on the results of sessions conducted and any other data with which it is provided. As described above, the result preferably includes both a list of possible defects corresponding to these collected data, and a probability of accuracy estimate associated with each of the listed defects.

At step 225, the troubleshooting engine 301 receives the results of the PPC analysis in what may be referred to as a PPC analysis report. This report generally comes from the PPC analysis module 401, but may also be received from the dynamic knowledge database 101 if it was previous compiled and stored there. At this step any other relevant information, such as the defective product report, is also provided unless it has already been transmitted. Note that the defective product report comes largely from the customer, possible one interacting with a service technician, that has been put into a recognizable form for use by the troubleshooting engine 301. Depending on its sophistication, of course, the troubleshooting engine 301 may use input only from a simple form filled out on a computer, audio responses to standard questions, or it may be able to accept “natural language” reports in either text or audio form, or perhaps a through a combination of any of these methods.

Note that as the process 200 is being executed, the service technician may be given the option to terminate it and simply proceed based on the information provided to that point (step not shown). This option may be useful where an obvious solution has become apparent. Assuming this does not occur, however, at this point the troubleshooting engine 301 performs initial assembly of a multimedia presentation for the guidance of the repair technician in starting the repair process (step 230). Note that for convenience herein, “repair” will mean diagnosis, repair, replace and return product to factory, and related operations. Also, while the disclosure is made using the example of a repair technician in a service center, it applies as well to another in a different location, for example, a consumer using a wireless connection involving the product itself in order to transmit PPC data, and a personal computer connected through the internet to receive multimedia instructions. In this sense “service technician” refers to anyone performing a “repair”.

The assembly of the multimedia process begins, of course, based on the information originally provided to the troubleshooting engine 301. It will almost always include an interactive portion to elicit responses to specific questions meant to inform the repair process. As with the initial report, these responses may be in any usable form. Once the initial portion of the multimedia presentation is assembled, it is transmitted to the service technician (step 235). The service technician then begins to act on the information and supply the responses required. At the very least, the service technician will presumably respond that the issue has been resolved. The resolution may or may not have been reached with the aid of the troubleshooting engine, but at such time the multimedia session is no longer required. As the service technician responds to the multimedia guide's queries, the responses are transmitted back to the troubleshooting engine (either as they are made, or in a batch after a group of queries have been addressed).

The troubleshooting engine 301 receives the service technician's responses (step 240), and adds them to the data file 330 storing information related to the product whose repair is in process. It also uses the information, either by itself or cumulatively with other stored data, to add to or amend the multimedia guide session (step 245). The revised or supplemented guide is then transmitted back to the service center (step 235). Steps 240, 245, and 235 are repeated as often as necessary. If, at any time in the received responses (step 240), there is an indication that the repair is complete, the process moves on to completion and follow-up (step 250). Here, the repair operation is closed-out, preferably including an analysis of the information stored in the current repair data files to make sure it is complete. If not, a follow-up form is transmitted to the service center (return to step 235). Here also the process steps 240, receiving a response from the service technician, 250 session completion, and 235 transmitting additional information to the service center, may repeat as many times as necessary. In some presumably rare instances, a response received at step 240 will result in a re-opening of the repair process. When it is determined at step 250 that the process is completed, the session is completed and any appropriate historical information is stored in the dynamic knowledge database (step 255).

In another embodiment (not shown) the service technician is regularly provided with (or may request) the opportunity to manually enter observations and suggestions as the repair is being conducted. These may be used for the current session only or saved and applied to the knowledge database 101. Any repair report being submitted may of course be submitted in the multimedia session itself. In one embodiment, the events of the current repair session are stored and automatically used to generate a report, or inserted into a report form that is then presented to the service technician for review. The report as presented may then be amended or supplemented by the technician, although in this case it may be preferable to also maintain an un-amended version for comparison.

Note that the sequence provided above is exemplary, and the steps of process 200 can be performed in any logically consistent order. For example, the multimedia session may begin immediately with a standard introduction, which guides the user through filling out an initial defect report and PPC count download process. Note also that not all of the steps will need to be performed for each repair, for example PPC counts may not be needed where the defect report appears to adequately define the problem.

The embodiments described above are preferred examples for implementing the invention, and the scope of the invention should not necessarily be limited by this description. The scope of the present invention is defined by the following claims.

In the claims:

1. A troubleshooting engine, comprising:
a communication module for receiving repair information relating to a product being repaired by a service technician;
a memory device in communication with the communication module for storing at least some of the received repair information; and
an assembly module for assembling a customized electronic repair guide based on the stored repair information, the repair guide for transmitting to the service technician and use in executing the repair.

2. The troubleshooting engine of claim 1, wherein the repair guide is a multimedia repair guide.

3. The troubleshooting engine of claim 2, further comprising a multimedia library for storing pre-recorded multimedia materials that may be used by the assembly module in assembling the multimedia repair guide.

4. The troubleshooting engine of claim 1, wherein the repair guide is an interactive repair guide.

5. The troubleshooting engine of claim 1, wherein the electronic repair guide is transmitted to the service technician through the communication module.

6. The troubleshooting engine of claim 1, wherein the communication module receives the repair information through a communications network.

7. The troubleshooting engine of claim 6, wherein the communications network is the Internet.

8. A distributed service system for assisting service technicians in performing repairs on a product, comprising:
a database for storing historical information related to making repairs on product, the historical information comprising product repair information reported by a service technician after performing repairs on another product similar to the product being repaired; and
a troubleshooting engine in communication with the database for receiving repair information from the service technician and assembling a repair guide based at least in part on the received information and on the historical information stored in the database.

9. The system of claim 8, further comprising a product performance counter (PPC) analysis module for receiving PPC counts from the product and using them to assemble a PPC report, wherein the troubleshooting engine is in communication with the PPC analysis module to receive the PPC report and assembles the repair guide at least in part based on the received PPC report.

10. The system of claim 8, wherein the repair guide is an interactive multimedia repair guide.

11. The system of claim 10, wherein the interactive multimedia repair guide prompts the service technician executing the product repair to provide information for a repair report.

12. The system of claim 10, wherein the repair report is used to supplement the historical information stored on the database.

13. A method of assisting a service technician in the repair of a defective product using a multimedia guide, comprising the steps of:
collecting data related to reported defects in products that the service technician is expected to repair and storing the data in a database;
providing a troubleshooting engine for receiving repair-related information from the service technician and using it to prepare the multimedia repair guide for transmission to the service technician that is tailored to the received information, wherein the repair guide is at least in part based in the data related to reported defects stored in the database.

14. The method of claim 13, wherein the repair-related information includes at least one PPC count, and further comprising the steps of:
generating a PPC profile using the PPC count; and
using the PPC profile to prepare the repair guide.

15. The method of claim 14, wherein the data stored in the database includes at least one reference PPC profiles corresponding to known defects in a product, and wherein the step of using the PPC profile to prepare a repair guide includes the step of comparing the PPC profile to the at least one reference PPC profile to determine if they are similar.

16. The method of claim 13, further comprising the step of comparing the received repair information to the data stored on the database to determine at least one possible defect cause.

17. The method of claim 16, wherein the comparing step results in the determination of a plurality of possible defect causes, and further comprising the step of assigning a predicted likelihood that any one of the possible defect causes will prove to be the cause of the defect in the product being repaired similar.

18. The method of claim 17, wherein the multimedia repair guide consists of a number of separate segments to be presented in a particular order, and wherein the particular presentation order is determined at least in part by the predicted likelihood assigned in the assigning step.
